(19) United States
(12) Patent Application Publication
(10) Pub. No.: US 2008/0098204 A1
(43) Pub. Date: Apr. 24, 2008

(54) Method And Apparatus For Improving The Efficiency Of A Processor Instruction Pipeline

(75) Inventor: Atsushi Hayashi, Austin, TX (US)

Correspondence Address: KAPLAN GILMAN GIBSON & DERNIER L.L.P., 900 ROUTE 9 NORTH, WOODBRIDGE, NJ, 07095, US

(73) Assignee: Sony Computer Entertainment Inc., Tokyo (JP)

(21) Appl. No.: 11/551,833

(22) Filed: Oct. 23, 2006

(51) Int. Cl. G06F 15/00

(52) U.S. Cl. 712/220

(57) ABSTRACT

A system and method are disclosed which may include providing a processor instruction pipeline having a main line and a branch line; executing at least one wait cycle for at least one wait instruction in said pipeline; and advancing at least selected instructions, that are initially located subsequent to at least one wait instruction in said pipeline, through the pipeline during the at least one wait cycle.

### BACKGROUND OF THE INVENTION

The present invention relates to methods and apparatus for improving the efficiency of processor instruction pipeline within a pipelined processing system.

In recent years, there has been an insatiable desire for faster computer processing data throughputs because cutting edge computer applications involve real time, multimedia functionality. Graphics applications are among those that place the highest demands on a processing system because they require such vast numbers of data accesses, data computations, and data manipulations in relatively short periods of time to achieve desirable visual results. These applications require extremely fast processing speeds, such as many thousands of megabits of data per second.

Processors may employ pipelining to improve performance in light of the ever-increasing demands for processor performance. The execution of any instruction typically includes several distinct stages. Pipelining enables some or all of these stages to be acted upon concurrently, rather than consecutively, thereby expediting the processing of instructions through a processor. However, pipelining can be hindered by a lack of ideal synchronization of various concurrent tasks. Specifically, pipelining may be limited by the need by some instructions to access data produced by the completion of other instructions, when the data is not yet ready. Such situations can lead to wasted execution cycles within a processor pipeline. Accordingly, there is a need in the art for improved efficiency within processor pipelines.

### SUMMARY OF THE INVENTION

According to one aspect, the present invention provides methods and apparatus that may include providing a processor instruction pipeline having a main line and a branch line; executing at least one wait cycle for at least one wait instruction in the pipeline; and advancing at least selected instructions, that are initially located subsequent to at least one wait instruction in the pipeline, through the pipeline during the at least one wait cycle.

According to another aspect, the present invention provides methods and apparatus that may include providing a processor instruction pipeline having a main line and a branch line, the main line having initial and advanced portions; disposing a plurality of instructions within the pipeline; advancing the instructions from a first portion of the main line to the branch line and then to the second portion of the main line; executing at least one wait cycle by a wait instruction, of the instructions, in the pipeline; and advancing given ones of the instructions, that are initially located subsequent to the wait instruction in the pipeline, through the pipeline during execution of the at least one wait cycle.

According to yet another aspect, the present invention provides methods and apparatus that may include a) providing a processor instruction pipeline having a main line having an initial portion and an advanced portion and a branch line disposed between the initial portion and the advanced portion; b) disposing instructions within the processor instruction pipeline in an initial order; c) executing at least one wait cycle by at least one wait instruction in the main line advanced portion; d) executing at least one wait cycle by at least one wait instruction in the main line initial portion, the execution of steps c) and d) occurring concurrently; and e) buffering a selection of the instructions in the branch line during the concurrent execution steps.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram illustrating the structure of a processing system that may be used in accordance with one or more aspects of the present invention;

FIG. 2 is a block diagram of a processor instruction pipeline in accordance with one or more aspects of the present invention;

FIG. 3 is a block diagram of a processor instruction pipeline in accordance with one or more aspects of the present invention;

FIGS. 4-7 are block diagrams of the processor instruction pipeline of FIG. 3 at successive stages of instruction advancement therethrough in accordance with one or more embodiments of the present invention;

FIG. 8 is a block diagram of a processor instruction pipeline in accordance with one or more other embodiments of the present invention;

FIG. 9-18 are block diagrams of the processor instruction pipeline of FIG. 8 at successive stages of instruction advancement therethrough, in accordance with one or more embodiments of the present invention;

FIG. 18 is a block diagram of a processor instruction pipeline in accordance with one or more embodiments of the present invention;

FIGS. 19-29 are block diagrams of the processor instruction pipeline of FIG. 18 at successive stages of instruction advancement therethrough in accordance with one or more embodiments of the present invention;

### DETAILED DESCRIPTION OF THE PREFERRED EMBODIMENTS

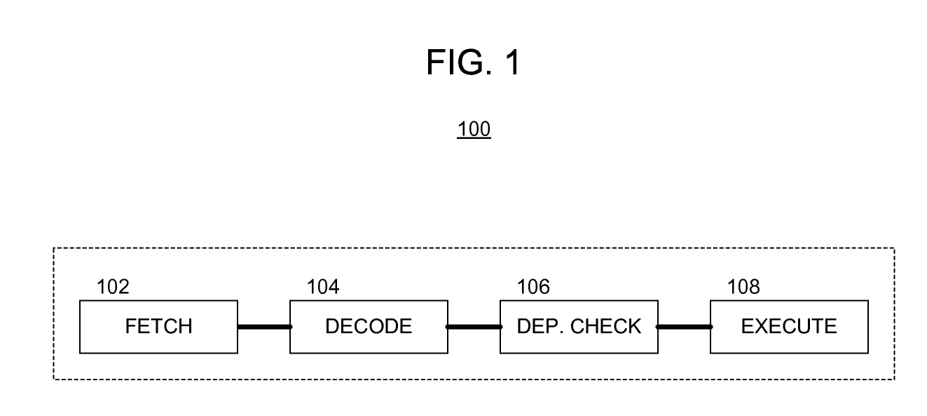

With reference to the drawings, wherein like numerals indicate like elements, there is shown in FIG. 1 at least a portion of a processing system (processor) 100 that may be adapted for carrying out one or more features of the present invention. For the purposes of brevity and clarity, the block diagram of FIG. 1 will be referred to and described herein as illustrating an apparatus 100, it being understood, however, that the description may readily be applied to various aspects of a method with equal force.

The processing system 100 is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processing system 100 may include an instruction buffer (not shown), an instruction fetch circuit 102, an instruction decode circuit 104, a dependency check circuit 106, instruction issue circuitry (not shown), and instruction execution stages 108.

The instruction fetch circuitry 102 is preferably operable to facilitate the transfer of one or more instructions from a memory to the instruction buffer, where the instructions are queued up for release into the pipeline. The instruction buffer may include a plurality of registers that are operable to temporarily store instructions as they are fetched. The instruction decode circuit 104 is adapted to break down the instructions and generate logical micro-operations that perform the function of the corresponding instruction. For example, the logical micro-operations may specify arithmetic and logical operations, load and store operations to the memory, register source operands and/or immediate data operands. The instruction decode circuit 104 may also indicate which resources the instruction uses, such as target register addresses, structural resources, function units and/or busses. The instruction decode circuit 104 may also supply information indicating the instruction pipeline stages in which the resources are required.

The dependency check circuit 106 includes a plurality of registers, where one or more registers are associated with each execution stage of the pipeline. The registers store indications (identification numbers, register numbers, etc.) of the operands of the instructions being executed in the pipeline. The dependency check circuit 106 also includes digital logic that performs testing to determine whether the operands of an instruction for entry into the pipeline are dependent on the operands of other instructions already in the pipeline. If so, then the given instruction should not be executed until such other operands are updated (e.g., by permitting the other instructions to complete execution).

The instruction execution circuitry 108 preferably includes a plurality of floating point and/or fixed point execution stages to execute arithmetic instructions. Depending upon the required processing power, a greater or lesser number of floating point execution stages and fixed point execution stages may be employed. It is most preferred that the instruction execution circuitry 108 (as well as the other circuits of the processing system 100) is of a superscalar architecture, such that more than one instruction is issued and executed per clock cycle. With reference to any given instruction, however, the execution circuitry 108 executes the instructions in a number of stages, where each stage takes one or more clock cycles, usually one clock cycle.

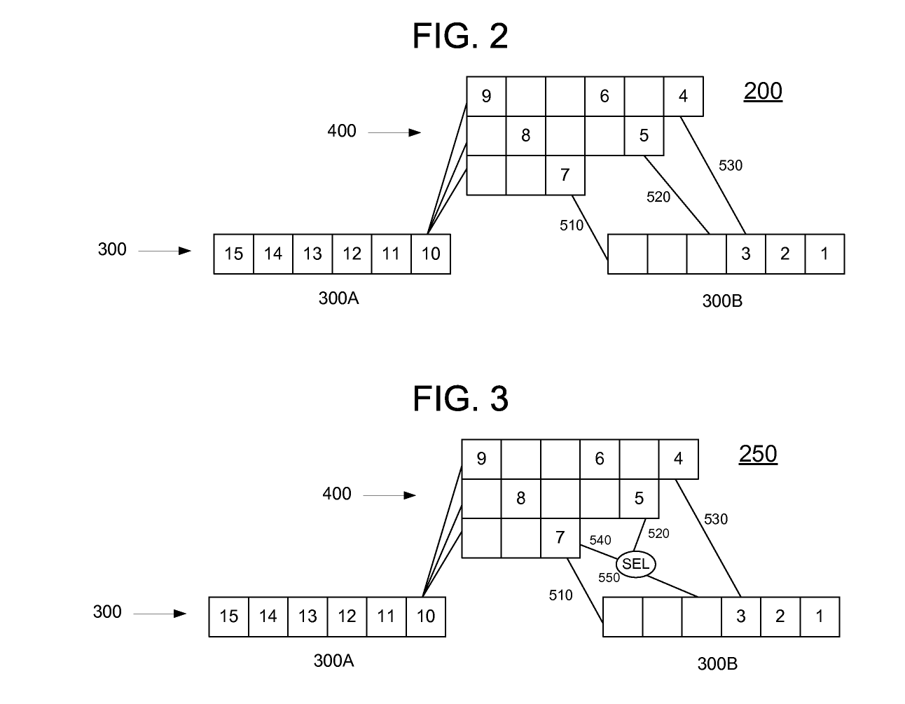

FIG. 2 is a block diagram of a processor instruction pipeline 200 in accordance with one or more embodiments of the present invention.

In one or more embodiments, the various portions of processor instruction pipeline 200 shown in FIG. 2, and discussed below, may be implemented within one or more of the circuits (102-108) of apparatus 100, discussed above. However, the specific constituent portions of processor instruction pipeline 200 do not necessarily correspond to the respective individual circuits forming apparatus 100.

In one or more embodiments, processor instruction pipeline (pipeline) 200 may include main line 300, branch line 400, and transfer paths 510, 520, and 530. Main line 300 may include main line initial portion 300A and main line advanced portion 300B. Preferably, each square in main line 300 and in branch line 400 corresponds to a single “stage” of processor instruction pipeline 200. Preferably, each instruction advances one stage for each clock cycle of pipeline 200 and processor 100.

Branch line 400 may include one or more branch line segments which may include the horizontal arrangements of stages shown in FIG. 2. Within such segments, as within the portions of main line 300, the “last stage” (final stage) is the right-most stage, and a more advanced stage is to the right of a less advanced stage.

In one or more embodiments, transfer paths 510, 520, and 530 are paths along which instructions may be transferred from branch line 400 to main line advanced portion 300B.

To aid in describing one or more embodiments of the invention, a description a conventional flow of instructions through pipeline 200 is provided here. Instructions may be queued in main line initial portion (initial portion) 300A, which in FIG. 2 contains instructions 10 through 15. The instructions in main line initial portion 300A are preferably dispatched in succession to a selected segment of branch line 400. In one or more embodiments, each segment within branch line 400 may be assigned to one instruction type, a group of instructions having one or more characteristics in common, and/or an instruction set. Thus, segment selection may be instruction-type-specific and/or instruction-set-specific. However, there is generally not a fixed assignment of branch line 400 segments to particular instructions or instruction types. Instead, the association of segments with instructions and/or with groups of related instructions may vary with the operation of pipeline 200 and/or with that of processor 100.

For the sake of clarity herein, we assign names for the relative locations of instructions within pipeline 200. Given instructions slated for passage through pipeline 200 after other instructions are considered to be “behind” the other instructions. The given instructions themselves may be referred to as “subsequent instructions” in relation to the other instructions. The “other instructions” referred to above are referred to as being “ahead of”, “in front of” and/or “forward of” the given instructions. The other instructions themselves may be referred to as “preceding instructions” in relation to the given instructions.

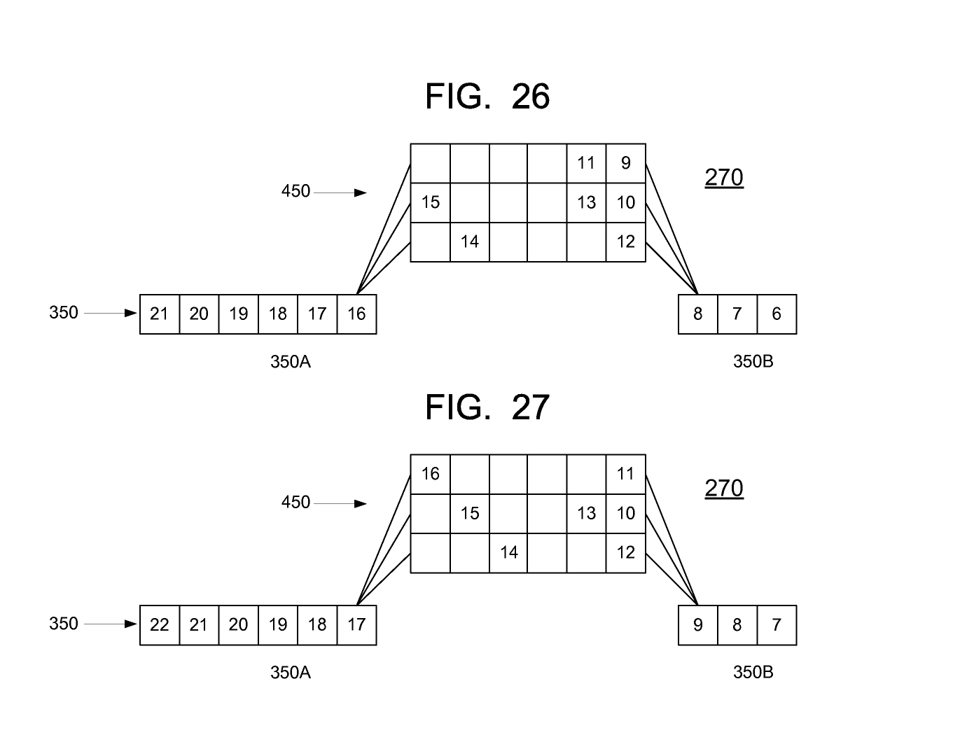

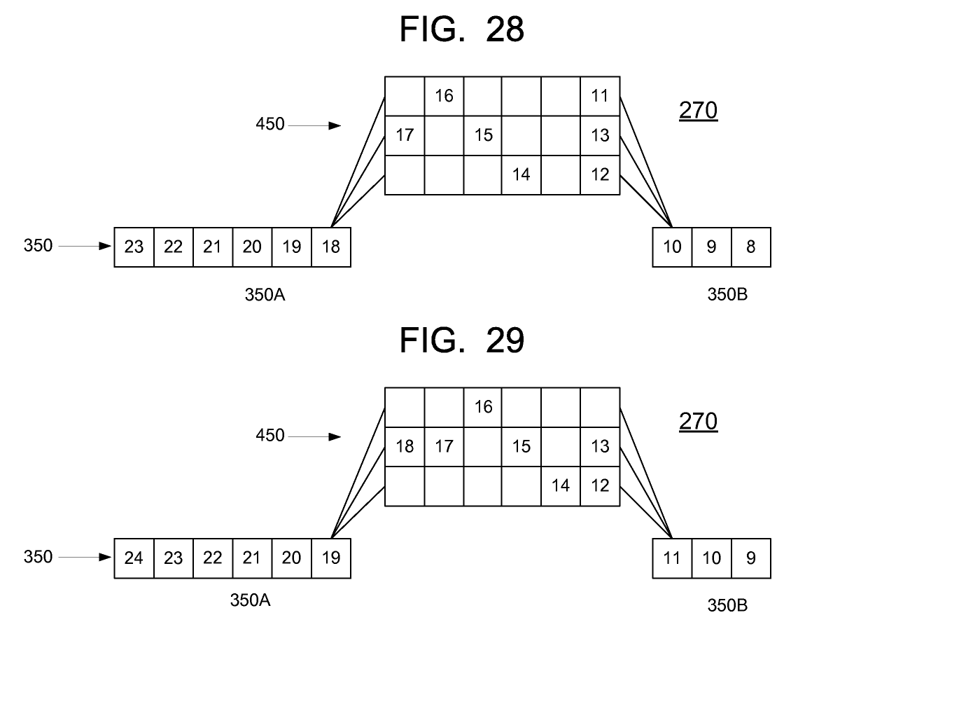

For example, in FIG. 2, instruction 8 is “behind” instruction 7. This terminology is consistent with the forward direction of instruction movement within pipeline 200 being from left to right in FIGS. 2-29 of this application. With instruction 7 as a reference point, instruction 8 may also be referred to as being a subsequent instruction. With instruction 8 as a reference point, instruction 7 may be referred to as being a “preceding instruction.”

The assignment of branch line 400 segments to instructions and/or instruction types may be established such that instructions that are more likely to execute wait cycles are directed to the lowest (as illustrated in FIGS. 2-17) available branch line 400 segment. Otherwise stated, one or more embodiments of the present invention may operate more efficiently when instructions more likely to execute wait cycles are directed to the shorter branch line 400 segments, which, in the embodiment of FIG. 2 are generally also the “lower” branch line 400 segments. However, in one or more alternative embodiments, branch line 400 segment assignments may deviate from this general principle.

Herein, executing a wait cycle generally corresponds to passively or actively causing an instruction to stand still (remain within the same stage) within pipeline 200 during a clock cycle of pipeline 200 and/or of processor 100.

Each instruction may advance one stage per execution cycle within its branch line 400 segment until it reaches the last stage in that segment. In the clock cycle succeeding an instruction's arrival at the final stage of its branch line 400 segment, the instruction may proceed along a transfer path (which may be one of 510, 520, and 530 or other path) to the stage in main line advanced portion 300B at the other end of that transfer path. The foregoing is generally applicable to the embodiments illustrated in FIGS. 2-17.

In order to illustrate the operation of one or more embodiments of the present invention, an example is considered in which instruction 7, as shown in FIG. 2, is a wait instruction which is handled in accordance with the embodiment of FIG. 2.

Typically, instructions advance one stage for each clock cycle within their respective segments of branch line 400. Thus, if instruction 7 executes two wait cycles and does not move, it may be seen that instruction 8 would advance two stages and end up one segment up, and one stage to the right of instruction 7. One cycle later, instruction 7 would advance to the left-most stage of main line advanced portion 300B, and instruction 8 would advance to the right-most stage of the middle segment of branch line 400. Another cycle later, instruction 7 would advance to the second (from the left) stage of advanced portion 300B, and instruction 8 would advance to the third (from the left) stage of advanced portion 300B.

Thus, instructions 7 and 8 would now be located in the wrong order within main line advanced portion 300B. And, in the exemplary embodiment of FIG. 2, the single-segment structure of advanced portion 300B may preclude suitably re-ordering these two instructions.

To avoid the problem of improper ordering of instructions described above, instructions subsequent to a wait instruction, like instruction 7, generally stop advancing through pipeline 200 once instruction 7, or any other wait instruction, begins executing one or more wait cycles. However, halting the progress of the subsequent instructions (which are usually higher-numbered instructions) as described may cause one or more execution cycles to be wasted by creating gaps, that is, empty stages, within pipeline 200. Herein, a first instruction is “behind” a second instruction when the first instruction is situated to the left of the second in the initial order of instructions within main line initial portion 300A, as shown in FIG. 2. The left and right directions are used herein for convenience, in connection with the illustrations in the figures. It will be appreciated that the present invention is not limited to any particular spatial relation between adjacent stages of the processor instruction pipelines depicted in the Figures.

Accordingly, it would be desirable to enable instructions located behind a wait instruction in pipeline 200 to keep moving during the execution of one or more wait cycles by the wait instruction, without causing the instructions to be placed in main line advanced portion 300B in an incorrect order.

The following provides a discussion of various embodiments in which instructions initially located behind a wait instruction in a processor instruction pipeline may continue advancing during the execution of wait cycles, while still enabling the initial order (original order) of the instructions within the pipeline to be preserved and/or restored.

FIG. 3 is a block diagram of a processor instruction pipeline 250 in accordance with one or more aspects of the present invention. Pipeline 250 of FIG. 3 includes many of the same constituent elements as pipeline 200 of FIG. 2. Accordingly, a list of the common elements is not repeated in this section.

In addition to the elements recited in connection with pipeline 200 of FIG. 2, pipeline 250 of FIG. 3 may include selector 550 and transfer path 540 from branch line 400 to main line advanced portion 300B.

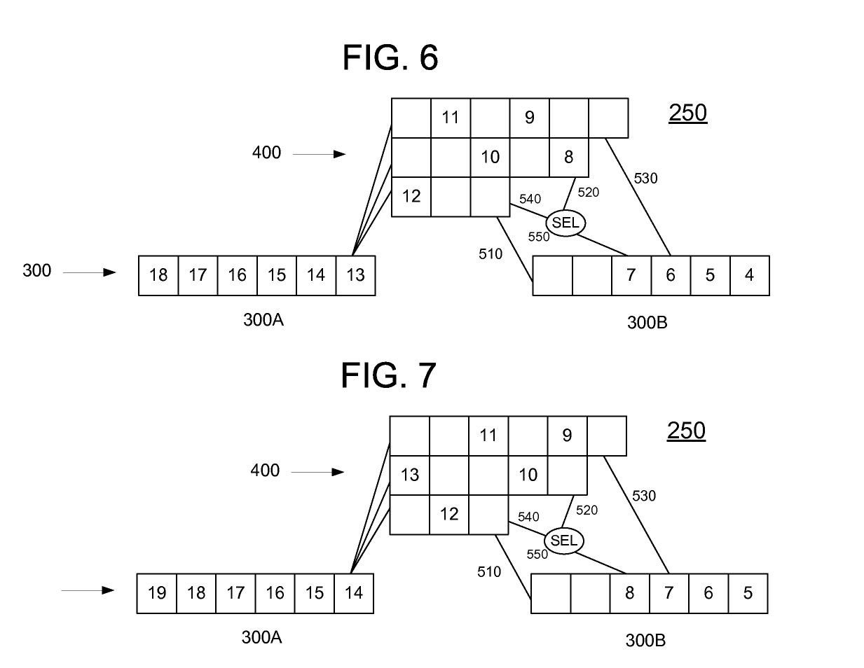

In one or more embodiments, two or more selection operations may be performed within pipeline 250. A first selection operation may involve having a final stage (right-most stage) in any segment of branch line 400 determine which main line advanced portion 300B stage an instruction will be transferred to. By way of example, it may be seen that between the state shown in FIG. 5 and that shown in FIG. 6, instruction 7 has been transferred from the final stage of the lowest segment of branch line 400 to the third (from the left) stage of main line advanced portion 300B along transfer path 540. The above-described selection operation may be implemented within the final stage of the bottom segment of branch line 400 using software, hardware, or a combination of the two.

In one or more embodiments, the first selection operation discussed above may be enabled by including data with each instruction indicating the number, if any, of wait cycles executed by that instruction. Upon acquiring such wait cycle execution data, the first selection operation may cause the pertinent instruction to skip a number of stages within main line advanced portion 300B that corresponds to the number of executed wait cycles.

By way of example, it may be seen that between the state shown in FIG. 5 and that shown in FIG. 6, instruction 7 has been transferred from the final stage of the lowest segment of branch line 400 to the third (from the left) stage of main line advanced portion 300B, thereby skipping two stages within main line advanced portion 300B. As discussed later herein, the two skipped stages correspond to the two wait cycles executed by instruction 7 while located within branch line 400. The above-described selection operation may be implemented within branch line 400 using software, hardware, or a combination of the two.

In one or more embodiments, a second selection operation may include having a stage within main line advanced portion 300B select a source stage from which to receive an instruction, where more than one source stage is available. Selector 550 may perform this function using software, hardware, or a combination of both.

In one or more embodiments, the four following conditions are preferably satisfied in order for the system of FIG. 3 to operate in a preferred manner.

The sum of the number of wait cycles executed by the wait instruction (instruction 7 in the system of FIG. 3) and the number of stages in the segment the wait instruction is located in preferably does not exceed the number of stages in the longest branch line 400 segment.

The instruction (instruction 8 in the embodiment of FIG. 3) immediately following the wait instruction is preferably not dispatched to the same branch line segment as the wait instruction itself.

Once it is determined that a wait instruction will begin executing one or more wait cycles, pipeline 250 preferably discontinues dispatching instructions to the branch line 400 segment that wait instruction is in.

The instructions in the branch line 400 preferably do not depend on data from instructions outside the branch line 400.

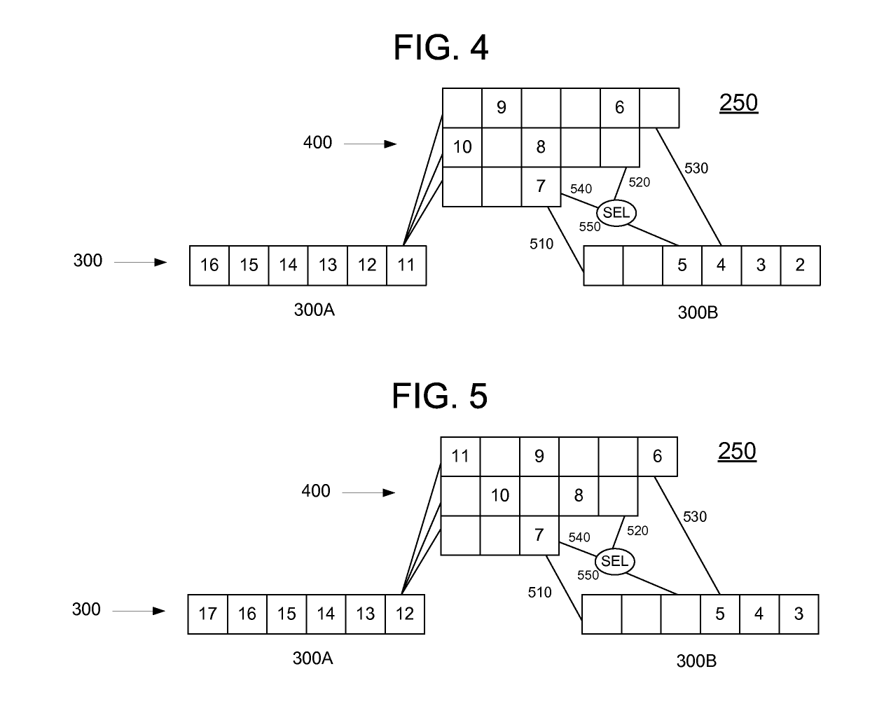

The following discusses the operation of the embodiment of FIG. 3 when faced with the same initial conditions as those described above in connection with FIG. 2. Specifically, the embodiment of FIG. 3 begins with the same instructions located in the same respective stages of the pipeline (which is pipeline 250 in the case of FIG. 3) as was the case with FIG. 2. Moreover, the sequence of events discussed in connection with FIG. 3 starts with instruction 7 executing two consecutive wait cycles (wait instructions). FIGS. 4-7 show the apparatus of FIG. 3 at successive stages of instruction advancement through pipeline 250, in accordance with one or more embodiments of the present invention.

It will be understood by those of ordinary skill in the art that the following is an example of instruction advancement through pipeline 250 employing one or more embodiments of the present invention, and that the present invention is not limited to the specific exemplary instruction flow.

Continuing with the example, FIG. 4 shows the state of pipeline 250 one execution cycle later than the state shown in FIG. 3. During this cycle, wait instruction 7 has executed a wait cycle and has not moved. It may be seen that in this embodiment, the instructions that were initially subsequent to instruction 7 in pipeline 250 have advanced. Specifically, instructions 8 and 9 have moved one stage to the right in their respective branch line 400 segments. Instructions 4 and 5 have moved along transfer paths 530 and 520, respectively, to main line advanced portion 300B.

Continuing with the example, FIG. 5 shows pipeline 250 in a state one execution cycle later than the state shown in FIG. 4. It may be seen that the instructions in the main line advanced portion 300B have all advanced. Similarly, it may be seen that the instructions, except for instruction 7, that were already in branch line 400, in the state shown in FIG. 4, have also advanced one stage. Moreover, instruction 11 has moved, or been “dispatched,” from main line initial portion 300A to branch line 400. In the pipeline 250 state shown in FIG. 5, instruction 7 has completed its two wait cycles.

Continuing with the example, FIG. 6 shows pipeline 250 one execution cycle later than the state shown in FIG. 5. Instructions 8-11 that were already in branch line 400 have advanced one stage in their respective branch line 400 segments, and instruction 12 has advanced from main line initial portion 300A to branch line 400. Moreover, the instructions in main line advanced portion 300B have advanced by one stage, and instruction 6 has advanced along transfer path 530 to the fourth (from the left) stage in main line advanced portion 300B.

In one or more embodiments of the present invention, instruction 7 may advance along transfer path 540 to the third (from the left) execution stage of main line advanced portion 300B. Preferably, instruction 7 has skipped a number of stages in main line advanced portion 300B that corresponds to the number of wait cycles it executed while within branch line 400. In this example, as discussed earlier, instruction 7 executed two wait cycles, and has, correspondingly, skipped two stages upon being transferred to main line advanced portion 300B.

In one or more embodiments, selector 550 may select which branch line 400 segment final stage to accept an instruction from for transfer to the third stage of main line advanced portion 300B. In the pipeline 250 state shown in FIG. 5, the final stage of the middle segment of branch line 400 is empty, and the final stage of the lowest segment of branch line 400 contains instruction 7. Accordingly, in this case the selection is readily made, and selector 550 preferably transfers instruction 7 along transfer path 540 to the third (from the left) stage of main line advanced portion 300B.

Continuing with the example, FIG. 7 shows pipeline 250 one execution cycle after the state shown in FIG. 6. The instructions in pipeline 250 have all advanced according to the principles discussed above. Thus, to avoid repetition, the details of the advancement of each instruction are not repeated here.

However, attention is directed to instruction 8 which has advanced along transfer path 520 to the third (from the left) stage of main line advanced portion 300B. Due to instruction 7 having skipped two stages, as described in connection with FIG. 6, instruction 8 is now located subsequent to instruction 7 in main line advanced portion 300B, thereby restoring the original order of these instructions within pipeline 250. Moreover, it may be seen that instructions 9 and 10 are positioned within branch line 400 such that they will advance along transfer paths 530 and 520, respectively, and be transferred to main line advanced portion 300B subsequent to instructions 7 and 8. This, as well, is consistent with the original order of these instructions in pipeline 250, that is, the order of the instructions prior to the execution of wait cycles by instruction 7.

In one or more embodiments, allowing instructions initially located subsequent to instruction 7 in pipeline 250 (such as instructions 8, 9, etc. . . . ) to advance while instruction 7 executed wait cycles, and advancing instruction 7 by extra or additional stages as discussed in connection with FIG. 6 enables pipeline 250 to avoid having wasted execution cycles, while still preserving the original order of the instructions and thereby preserving the integrity of the data processing operations occurring within pipeline 250. In this manner, one or more embodiments of the present invention may achieve superior processing efficiency than that available employing the embodiment of FIG. 2.

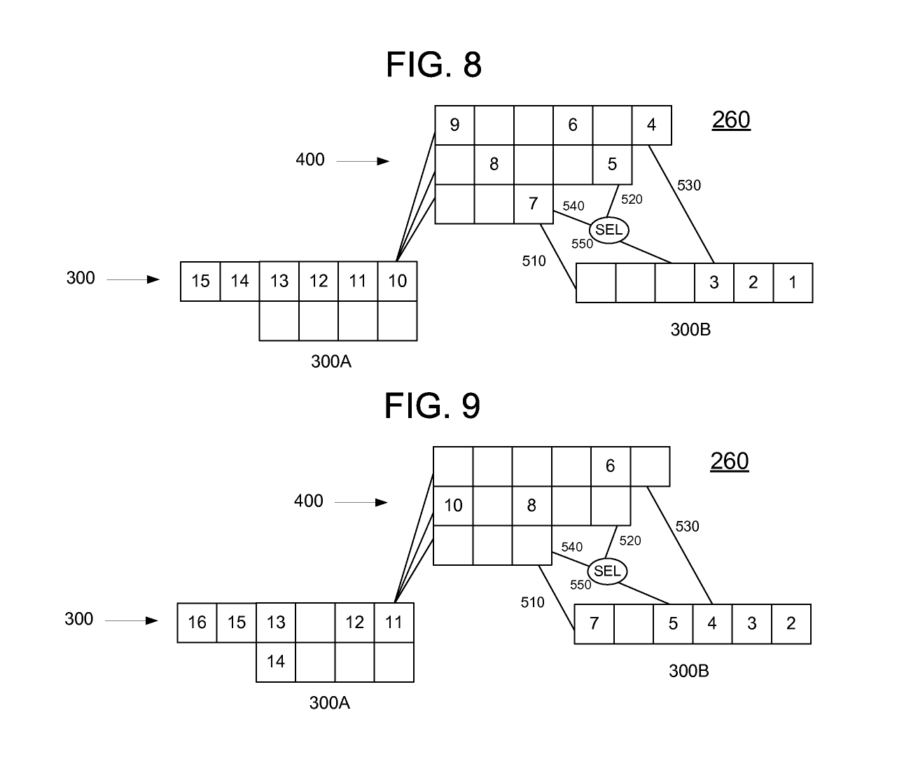

FIG. 8 is a block diagram of a processor instruction pipeline 260 in accordance with one or more embodiments of the present invention. FIG. 9-18 are block diagrams of processor instruction pipeline 260 of FIG. 8 at successive stages of instruction advancement therethrough, in accordance with one or more embodiments of the present invention.

In one or more embodiments, processor instruction pipeline (pipeline) 260 of FIG. 8 includes the same constituent parts as those described in connection with processor instruction pipeline 250 of FIG. 3, with the exception that main line initial portion 300A of pipeline 260 may include a second segment. To avoid needless repetition, the parts in common between the processor pipeline embodiments of FIGS. 3 and 8 are not discussed further herein.

The second segment, or “lower segment”, of main line initial portion 300A may have a length that corresponds to the length of the section of the upper segment (first segment) of main line initial portion 300A that extends from the stage at which a wait instruction executes one or more wait cycles to the stage at which instructions may be dispatched to branch line 400. In the exemplary pipeline 260 of FIG. 8, the pertinent section of the upper segment, and thus the length of the lower segment under discussion are both four stages long. However, the invention is not limited to including a lower segment having a length of four stages, and in alternative embodiments, the lower segment may include fewer or more than four stages. It will be appreciated that the term “below” is used for convenience in describing the embodiment of FIG. 8. The present invention does not require any particular geometric relation between the first and second segments of main line initial portion 300A, or for that matter, between any segments within any pipeline disclosed herein.

In the following discussion, which address FIGS. 8-18, the case in which a wait instruction executes wait cycles while in main line initial portion 300A is considered. As with the embodiment discussed in connection with FIGS. 3-7, the embodiments discussed below may beneficially enable instructions that are initially located subsequent to a wait instruction in processor instruction pipeline 260 to keep moving through pipeline 260 while a wait instruction, in this case instruction 13, executes wait cycles.

In one or more embodiments, the following conditions are preferably satisfied in order to enable non-wait instructions to advance while a wait instruction executes wait cycles.

In one or more embodiments, it is preferred that processing system 100 be aware of the branch line 400 segment that the instruction, that dispatched immediately prior the execution of a wait cycle, will be dispatched to.

In one or more embodiments, the sum of the number of executed wait cycles and the number of stages in the branch line 400 segment the wait instruction will be in after being dispatched preferably does not exceed the number of stages in the longest branch line segment.

In one or more embodiments, one or more instructions immediately subsequent to (succeeding) the wait instruction are preferably dispatched to a different branch line 400 segment than the one the wait instruction is dispatched to. More specifically, instructions succeeding the wait instruction, by advancing along the second segment of main line advanced portion 300A, referred to herein as “bypass instructions” are preferably dispatched to one or more branch line 400 segments other than the one the wait instruction is dispatched to. Dispatching the instructions in this manner preferably enables the wait instruction to advance through and exit branch line 400 ahead of the bypass instructions, thereby restoring and/or maintaining the original order of the instructions.

In one or more embodiments, each instruction in the second segment of the main line initial portion 300A is preferably independent of each other instruction in that segment.

In one or more embodiments, a wait instruction may include data indicative of the number of wait cycles it executed. When the wait instruction is transferred to main line advanced portion 300B from branch line 400, this wait-cycle data may be used to enable the wait instruction to skip a number of stages corresponding to the number of wait cycles executed thereby.

In one or more embodiments, the instructions in branch line 400 are preferably independent of data and/or operands associated with instructions outside of branch line 400.

As the apparatus is the same throughout FIGS. 8-18, the following discussion is directed to the instruction flow through pipeline 260. The general principles governing the flow of instructions through main line 300 and the branch line 400 segments was discussed above in connection with FIG. 2. Accordingly, to avoid repetition, that discussion is not repeated in this section.

It is noted that FIGS. 8-18 illustrate an exemplary flow of instructions through pipeline 260 in accordance with one or more embodiments of the present invention. The present invention is not limited to the details of the instruction flow illustrated in the drawings or described in the text below. In general, the flow of the instructions preceding the wait instruction 13 occurs in accordance with the general principles discussed earlier in this document, and is therefore not discussed in detail below. Moreover, in general, lower-numbered instructions depart the view of the following FIGS at the right of main line advanced portion 300B, and sequentially numbered, higher-numbered new instructions are introduced at the left of main line initial portion 300A. As such instruction flow is considered routine, the following text does not address the departing or newly introduced instructions in significant detail.

In FIG. 8, instructions 1-15 are shown within pipeline 260. It is noted that instruction 13 is a wait instruction and may remain immobile within one stage while executing wait cycles.

In one or more embodiments, FIG. 9 shows the state of pipeline 260 after instruction 13 has executed a wait cycle. It may be seen that the instructions 1-12 have advanced normally.

In one or more embodiments, to avoid having instructions initially located subsequent to instruction 13 in pipeline 260 halt their advancement during the execution of wait cycles by instruction 13, the subsequent instructions are provided with a second segment (the lower of two segments of main line initial portion 300A of FIGS. 8-18) of main line initial portion 300A along which to advance. Accordingly, in the view of FIG. 9, instruction 14 has preferably advanced along this second segment, while instruction 13 has preferably remained stationary.

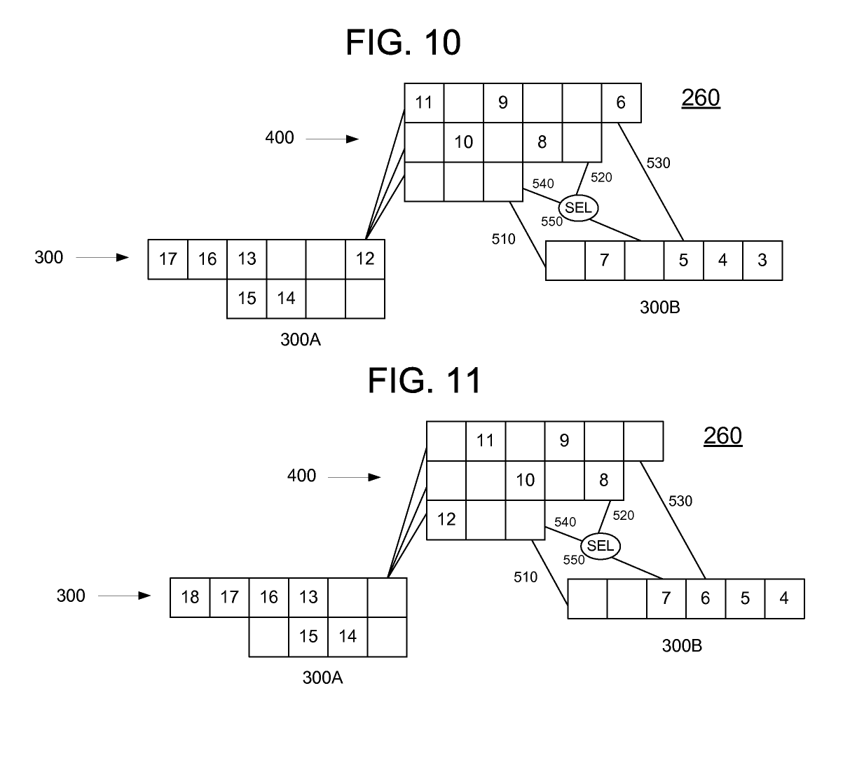

Directing attention to FIG. 10, it may be seen that instructions 2-12 have advanced normally. In the cycle the conclusion of which is shown in FIG. 10, instruction 13 preferably executes a another wait cycle and preferably remains in the same stage it was in, in the pipeline 260 state shown in FIGS. 8 and 9.

Instruction 14 preferably advances along the second segment of main line initial portion 300A. Moreover, following the path of instruction 14, instruction 15 preferably moves to the spare line stage just below instruction 13.

In the cycle the conclusion of which is shown in FIG. 11, instructions 3-12 have advanced normally. Directing attention to main line initial portion 300A, it may be seen that instructions 14 and 15 have advanced by one stage each along the second segment of initial portion 300A. At the same time, instruction 13, followed by instructions 16-18, has advanced along the upper segment of main line initial portion 300A.

Turning to FIG. 12, and directing attention to main line initial portion 300A, instructions 14 and 15 have preferably advanced by one stage each within the lower segment of initial portion 300A. At the same time, instruction 13 and instructions 16-19 have advanced along the upper segment of initial portion 300A.

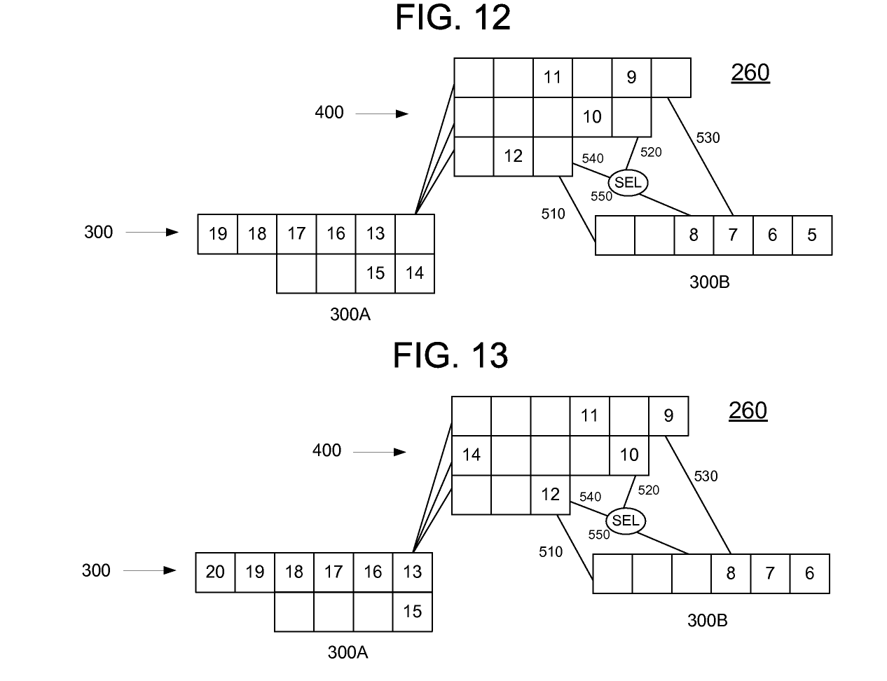

Attention is now directed to FIG. 13. It may be seen that instruction 14 has advanced, or been “dispatched,” from main line initial portion 300A to branch line 400. Instruction 15 has advanced one stage within the lower segment of initial portion 300A. And instructions 13 and 16-20 have advanced by one stage each along the upper segment of main line initial portion 300A.

It is noted that instruction 14 is, in some sense, “ahead” of instruction 13 within pipeline 260 in the pipeline state illustrated in FIG. 13. The instruction flow in the following FIGS illustrates how one or more embodiments of the present invention operate to restore an original order of the instructions within pipeline 260.

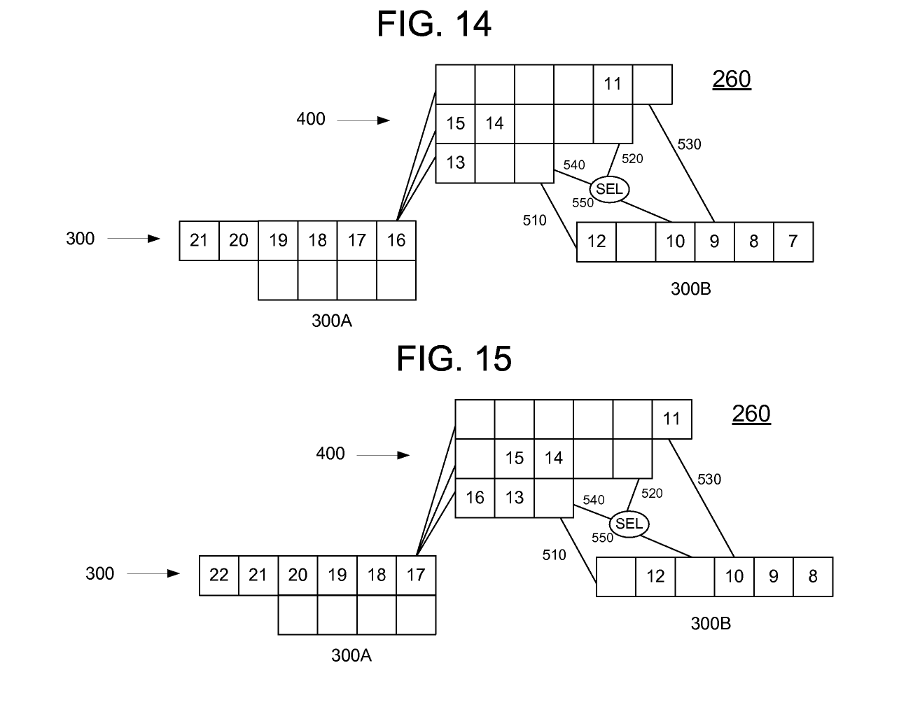

Directing attention to FIG. 14, instructions 13 and 15 have now both advanced, or been dispatched, to branch line 400 from main line initial portion 300A, leaving the second segment of main line initial portion 300A empty. Instruction 14 has advanced within its branch line 400 segment, and instructions 16-21 have advanced within main line initial portion 300A.

Directing attention to FIG. 15, instructions 13, 14, and 15 have advanced one stage each within branch line 400, and instruction 16 has been dispatched to branch line 400. Instructions 17-22 have advanced normally within main line initial portion 300A.

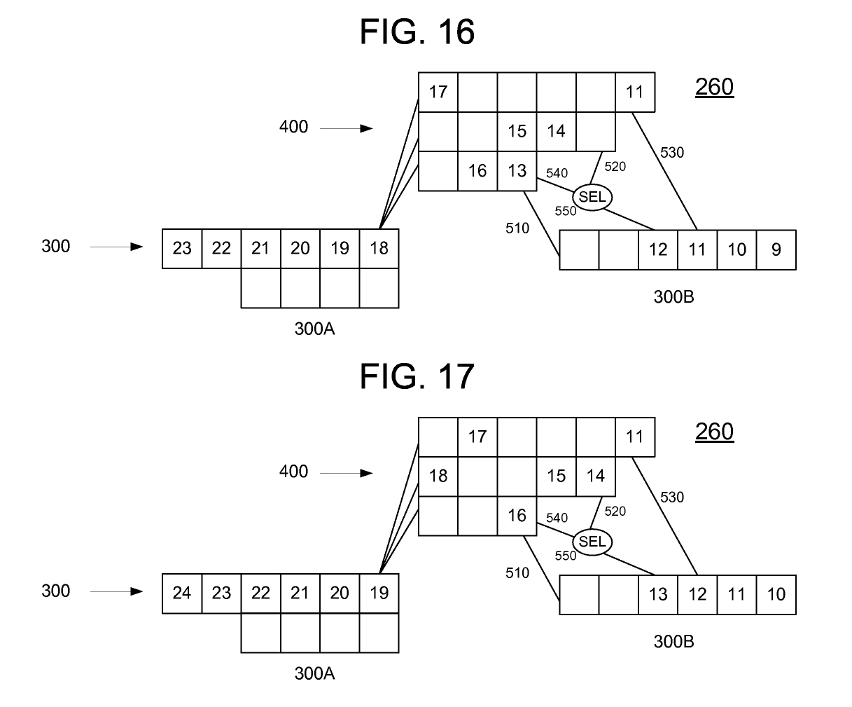

Directing attention to FIG. 16, instructions 13-16 have each advanced by one stage within branch line 400, and instruction 17 has been dispatched to the upper segment of branch line 400 from main line initial portion 300A.

Directing attention to FIG. 17, instruction 13 preferably advances along transfer path 540, with the aid of selector 550, to the third (from the left) stage of main line advanced portion 300B. Separately, instructions 14-24 have advanced conventionally within pipeline 260, with instruction 18 being dispatched to the middle segment of branch line 400.

In one or more embodiments, a selection operation within the last stage of the lowest segment of branch line 400 may be operable to cause instruction 13 to skip a number of stages, within main line advanced portion 300B, that corresponds to the number of wait cycles executed by wait instruction 13. In this case, instruction 13 executed two wait cycles, and has therefore skipped two stages within main line advanced portion 300B.

Selector 550 preferably operates to select from two possible sources within branch line 400 for delivery of an instruction, in this case instruction 13, to the third stage of main line advanced portion 300B. The first possible source is the final stage of the lowest segment, and the second possible source is the final stage of the middle segment of branch line 400. In the pipeline 260 state shown in FIG. 16, instruction 13 is located in the lowest segment's final stage, and the middle segment's final stage is empty. Accordingly, the decision is readily made, and selector 550 preferably operates to transfer instruction 13 along transfer path 540 to the third (from the left) stage of main line advanced portion 300B.

In the above example, the instructions initially located subsequent to instruction 13 in pipeline 260 were able to continue advancing through pipeline 260 during instruction 13's wait cycles, and a system and method in accordance with one or more embodiments of the present invention was able to restore the order of the instructions that prevailed prior to the execution of the wait instructions. Thus, the original order of the instructions was preserved while providing computational efficiency by keeping main line advanced portion 300B fully supplied with instructions (that is, avoiding any gaps in the pipeline) throughout the instruction advancement sequence shown in FIGS. 8-17.

Generally, wait cycles executed by wait instructions located in the initial and advanced portions of a main line are performed separately, causing the progress of both types of instructions through a processor instruction pipeline to stop. This practice imposes a burden on the processing efficiency the pipeline. Accordingly, it would be desirable to provide a more efficient method for handling wait cycles in a processor instruction pipeline.

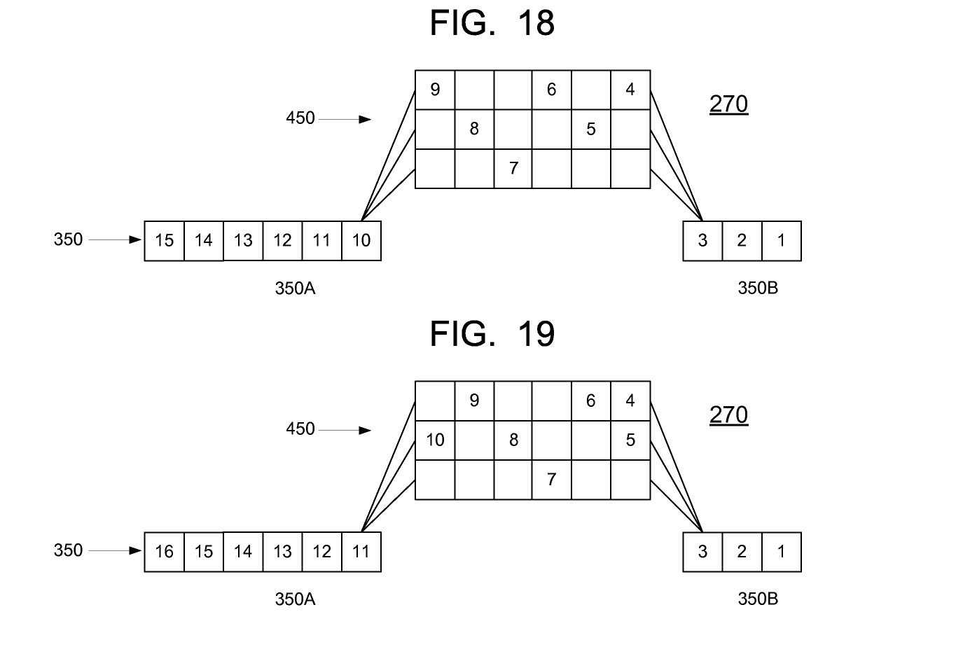

FIG. 18 is a block diagram of a processor instruction pipeline 270 in accordance with one or more embodiments of the present invention. FIGS. 19-29 are block diagrams of the processor instruction pipeline 270 of FIG. 18 at successive stages of instruction advancement therethrough in accordance with one or more embodiments of the present invention.

In one or more embodiments, processor instruction pipeline 270 may include main line 350 and branch line 450. Main line 350 may include main line initial portion 350A and main line advanced portion 350B. Preferably, suitable connections (transfer paths) are provided between main line initial portion 350A and branch line 450, and between branch line 450 and main line advanced portion 350B. While FIGS. 18-29 show branch line 450 having segments of equal length, segments of equal or of unequal length may be both used within with one or more embodiments of the present invention.

In one or more embodiments of the present invention, wait cycles may be concurrently executed by one or more wait instructions in the main line initial portion 350A and by one or more wait instructions in main line advanced portion 350B. Instructions located in between the two concurrently executing wait instructions may be buffered within branch line 450. Proceeding in this manner preferably avoids wasting execution cycles within pipeline 270.

The following constraints are preferably satisfied to enable operation of processor instruction pipeline 270 in accordance with one or more embodiments of the present invention.

In this embodiment, instruction sequence number information is preferably associated with each instruction to enable the transfer of instructions from the branch line 450 to the main line 350 in the proper order.

The instructions in branch line 450 preferably do not depend on data from instructions located outside branch line 450. Generally, where a dependency exists between two instructions within branch line 450, neither the dependent instruction nor the instruction having data that is depended upon may leave branch line 450 until the dependency is resolved.

If a given segment of branch line 450 is full, the dispatch of instructions from main line initial portion 350B to that segment preferably stops. Dispatch of instructions to the given branch line segment may resume only once the given branch line segment is no longer full.

FIG. 18 shows pipeline 270 with instructions disposed therein in an initial order, and numbered consecutively from 1 to 15. Each of FIGS. 19-29 show pipeline 270 at the conclusion of successive instruction execution cycles. It is noted that the FIGS. 18-29 demonstrate an example of the operation of one or more embodiments of the present invention and that the present invention is not limited to the specific sequence of wait cycles, instruction movements, and/or instruction numbers illustrated therein.

The following discussion focuses on aspects particular to one or more embodiments of the present invention. Accordingly, conventional advancement of instructions from one stage to the next within individual segments of main line 350 or branch line 450 are generally not addressed in significant detail below. Moreover, the advancement of instructions out of the view of the Figure sequence on the right-hand side, and the introduction of new instructions on the left-hand side of the FIGS is also not addressed in detail.

In one or more embodiments of the present invention, and with particular reference to branch line 450, instructions continue advancing one stage to the right for each clock cycle of pipeline 270 until a stage adjacent to stage having another instruction therein is reached, or until the final stage in that branch line 450 segment is reached. In this embodiment, instructions are not necessarily transferred from branch line 450 to main line 350 one cycle after reaching the final stage within a branch line 450 segment. The decision whether or not to transfer a given instruction in a final branch line 450 stage may depend upon a) the availability of an empty stage within main line advanced stage 350B and b) the sequence number of the given instruction in comparison with the sequence number of one or more other instructions that are available for transfer to main line advanced portion 350B. The foregoing instruction advancement discussion is applicable to one or more embodiments illustrated in FIGS. 18-29.

FIG. 18 shows an initial sequence of instructions within pipeline 270. A total of six instructions are disposed within branch line 450 in the pipeline 270 condition shown in FIG. 18.

Directing attention to FIG. 19, it may be seen that the instructions in main line advanced portion 350B have not advanced, due to instruction 1 executing a wait cycle. However, the instructions in main line initial portion 350A have advanced, as have most of the instructions in branch line 450.

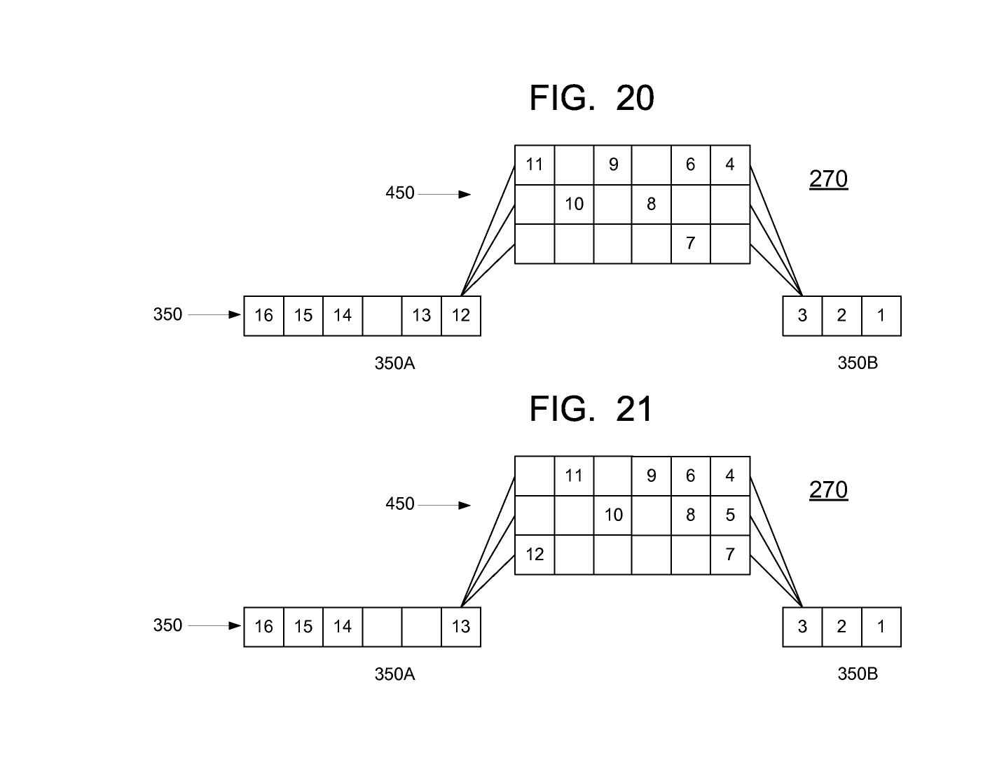

Continuing with the example, with attention to FIG. 20, it is noted that both instructions 1 and 14 have executed wait cycles in the preceding pipeline 270 cycle. Thus, while the instructions ahead of (lower-numbered than) instruction 14 in main line initial portion 350A have advanced, instructions located subsequent to instruction 14 will preferably remain stationary until instruction 14 stops executing wait cycles. Instruction 11 has been dispatched from main line initial portion 350A to branch line 450, and instructions 12 and 13 have advanced within main line initial portion 350A.

Continuing with the example, with attention to FIG. 21, instructions numbered 14 and higher remain stationary within main line initial portion 350A as do instructions 1-3 in main line advanced portion 350B. This lack of advancement is due to the execution of wait cycles by both instruction 1 and instruction 14.

Still referring to FIG. 21, instruction 12 has been dispatched to branch line 450, and instructions within branch line 450 that had empty stages to advance into, have also advanced by one stage. It is noted that in the pipeline 270 state depicted in FIG. 21, there are nine instructions in branch line 450.

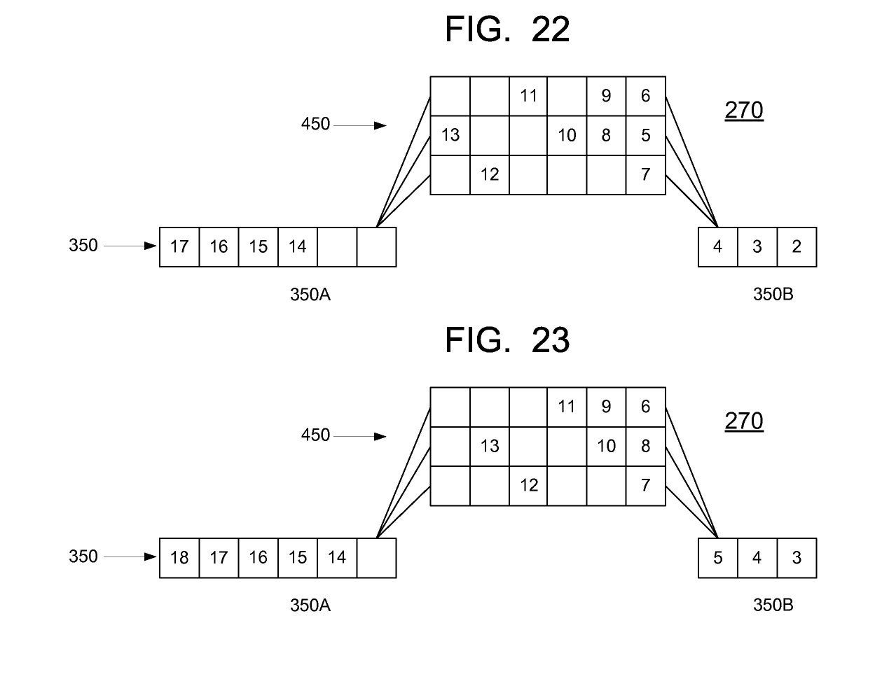

Continuing with the example, and with attention to FIG. 22, it is noted that the execution of wait cycles by instructions 1 and 14 has now concluded. Accordingly, all instructions in main line advanced portion 350B have advanced, and instruction 4 has been transferred from branch line 450 to main line advanced portion 350B.

The association of instruction sequence number information with each instruction preferably enables the system governing the advancement of instructions in pipeline 270 to select instruction 4 for transfer to main line advanced portion 350B from branch line 450, as shown in FIG. 22. This instruction sequence number information is preferably employed for all such instruction transfers from branch line 450 to main line advanced portion 350B to preserve and/or restore the initial order of instructions within main line 350 and thus in processor instruction pipeline 270.

Still referring to FIG. 22, instructions 14-17 (where instruction 17 is newly introduced into the portion of pipeline 270 visible in FIG. 22) have advanced within main line initial portion 350A. And instruction 13 has been dispatched from main line initial portion 350A to branch line 450.

As was the case in FIG. 21, there are nine instructions in pipeline 270 in the pipeline 270 state depicted in FIG. 22, as contrasted with the six instructions located therein in the pipeline 270 state depicted in FIG. 18. Therefore, in accordance with one or more embodiments of the present invention, pipeline 270 effectively employs branch line 450 as a F.I.F.O. (First-In, First-Out) buffer for instructions dispatched thereto during execution of the wait cycles by wait instructions 1 and 14 and thereby preferably avoids wasting execution cycles within pipeline 270.

Continuing with the example, and with attention to FIG. 23, it may be seen that instructions are now flowing through all portions of pipeline 270 without restriction. Instruction 5 has been transferred from branch line 450 to main line advanced portion 350B. No instruction was dispatched from main line initial portion 350A to branch line 450 in the cycle ending in the state shown in FIG. 23.

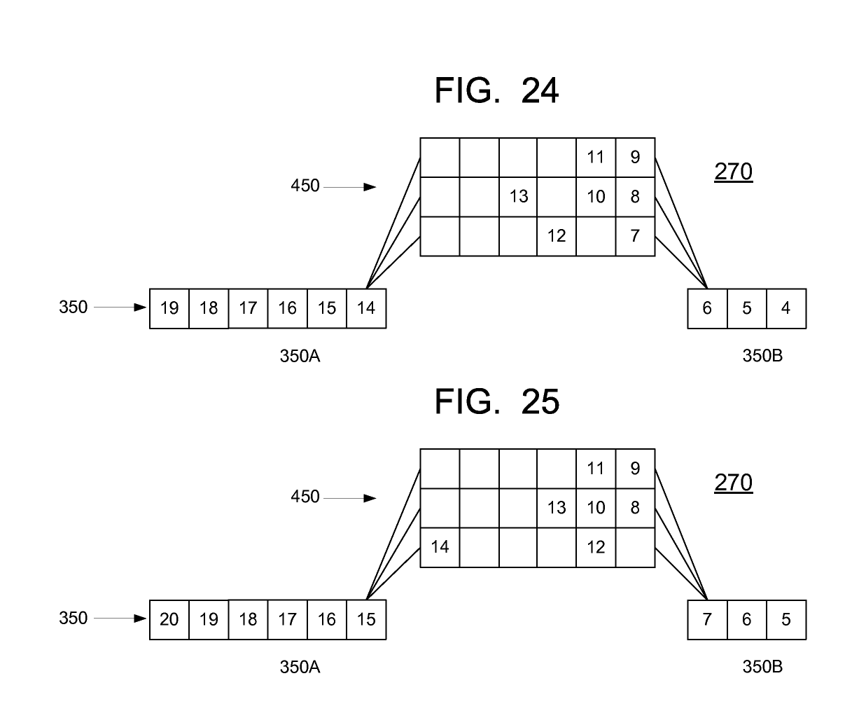

Continuing with the example, and with attention directed to FIG. 24, it may be seen that, once again no instruction was dispatched from main line initial portion 350A to branch line 450. Instruction 6 has been transferred from branch line 450 to main line advanced portion 350B. Instructions have advanced normally within branch line 450 and in portions 350A and 350B of main line 350.

For the sake of brevity, the remainder of the figures pertinent to this example are addressed together in this section. Between FIG. 25 and FIG. 29, no wait cycles are executed, and the instructions in all portions of pipeline 270 advance in accordance with the principles applicable to this embodiments, which were discussed earlier herein. Accordingly, the details of these instruction movements are not discussed in detail herein.

It may be seen that in spite of interruptions in the dispatching of instructions from main line initial portion 350A to branch line 450 and of the “crowding” of instructions within branch line 450, instructions are dispatched from branch line 450 to main line advanced portion 350B in the same order in which they entered pipeline 270 and without incurring any gaps (stages without instructions therein), which gaps may correspond to wasted execution cycles.

Thus, the original order of the instructions was preserved while providing computational efficiency by keeping main line advanced portion 300B fully supplied with instructions (that is, avoiding any gaps in the pipeline) throughout the instruction advancement sequence shown in FIGS. 18-29.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
providing a processor instruction pipeline having a main line and a branch line;
executing at least one wait cycle for at least one wait instruction in said pipeline; and
advancing at least selected instructions, that are initially located subsequent to at least one said wait instruction in said pipeline, through said pipeline during said at least one wait cycle.

2. The method of claim 1 further comprising:
causing said at least one wait instruction to skip a number of stages, within said pipeline, equal to a number of wait cycles executed thereby.

3. The method of claim 1 further comprising:
adjusting an order of transfer of at least a given one of said at least one wait instruction from said branch line to said main line based on a characteristic of said at least one given wait instruction.

4. A method, comprising:
providing a processor instruction pipeline having a main line and a branch line, said main line having initial and advanced portions;
disposing a plurality of instructions within said pipeline;
advancing said instructions from a first portion of said main line to said branch line and then to said second portion of said main line;
executing at least one wait cycle by a wait instruction, of said instructions, in said pipeline; and
advancing given ones of said instructions, that are initially located subsequent to said wait instruction in said pipeline, through said pipeline during execution of said at least one wait cycle.

5. The method of claim 4 further comprising:
moving said wait instruction ahead of said given instructions within said pipeline, after said advancement of said given instructions, thereby restoring an initial order of said instructions.

6. The method of claim 5 wherein said moving ahead said at least one wait instruction comprises:
transferring said wait instruction from said branch line to a more advanced stage in said main line advanced portion than any of said given instructions.

7. The method of claim 6 wherein said transferring step comprises:
selecting a path for transferring said wait instruction from said branch line to said more advanced stage in said main line advanced portion.

8. The method of claim 7 wherein said selecting said path comprises:
selecting a destination stage for said wait-instruction transfer by skipping a number of stages in said main line advanced portion equal to a number of wait cycles executed by said wait instruction.

9. The method of claim 4 wherein said executing step comprises executing said at least one wait cycle in said branch line.

10. The method of claim 9 wherein said advancing said given instructions comprises advancing said given instructions within their respective branch line segments during execution of said at least one wait cycle.

11. The method of claim 9 wherein a sum of a number of cycles executed by said at least one wait cycle and a number of stages in a segment of said branch line said at least one wait cycle is executed in is less than or equal to a number of stages in a longest segment of said branch line.

12. The method of claim 9 further comprising:
not dispatching an instruction, immediately following said wait instruction in said main line initial portion, to a same branch line segment as said wait instruction.

13. The method of claim 9 further comprising:
causing said wait instruction to skip a number of stages, in its advancement through said pipeline, equal to a number of wait cycles executed by said wait instruction.

14. The method of claim 13 wherein said skipping of stages is effected by a selector.

15. The method of claim 9 further comprising:
performing said advancing step only if instructions disposed within said branch line do not depend on data from instructions disposed outside said branch line.

16. The method of claim 4 wherein said executing step comprises executing said at least one wait cycle in said main line.

17. The method of claim 16 wherein said step of advancing said given instructions comprises advancing said given instructions along a second segment of said main line initial portion.

18. The method of claim 16 wherein a sum of a number of wait cycles executed by said wait instruction and a number of stages in a segment of said branch line that said wait instruction is dispatched to after executing said wait cycles is less than or equal to a number of stages in a longest segment of said branch line.

19. The method of claim 16 further comprising:
not dispatching an instruction immediately succeeding said wait instruction to a same segment of said branch line as said wait instruction.

20. The method of claim 16 further comprising:
providing a second segment for said initial portion of said main line extending from a stage at which said wait instruction is located to a last stage of said main line initial portion.

21. The method of claim 20 wherein each instruction located in said second segment is independent of each other instruction in said second segment.

22. The method of claim 16 further comprising:
associating, with said wait instruction, data indicative of a number of delay cycles executed thereby.

23. The method of claim 16 wherein instructions in said branch line are independent of instructions outside said branch line.

24. A processor instruction pipeline, comprising:
a main line having an initial portion and an advanced portion, each said portion including a plurality of stages;
a branch line disposed between said initial portion and said advanced portion and operative to receive instructions dispatched from said initial portion of said main line, said branch line including a plurality of stages;
a plurality of transfer paths operative to transfer instructions from said branch line to said advanced portion of said main line; and
a selector operative to select a first path for non-wait instructions and at least one other path for at least one wait instruction;

25. The processor instruction pipeline of claim 24 wherein said at least one other path is operative to cause said at least one wait instruction to skip a number of stages, upon being transferred to said main line advanced portion, that is equal to a number of wait cycles executed by said at least one wait instruction while within said processor instruction pipeline.

26. The processor instruction pipeline of claim 24 wherein said at least one wait instruction is operative to execute wait cycles within said branch line.

27. The processor instruction pipeline of claim 24 wherein said at least one wait instruction is operative to execute at least one wait cycle within said main line initial portion.

28. The processor instruction pipeline of claim 27 wherein said initial portion of said main line comprises:
at least a first segment and a second segment, said second segment extending from a stage at which said wait instruction executes said at least one wait cycle to a stage from which said instruction dispatching to said branch line occurs.

29. A method, comprising:
a) providing a processor instruction pipeline having a main line having an initial portion and an advanced portion and a branch line disposed between said initial portion and said advanced portion;
b) disposing instructions within said processor instruction pipeline in an initial order;
c) executing at least one wait cycle by at least one wait instruction in said main line advanced portion;
d) executing at least one wait cycle by at least one wait instruction in said main line initial portion, said execution of steps c) and d) occurring concurrently; and
e) buffering a selection of said instructions in said branch line during said concurrent execution steps.

30. The method of claim 29 further comprising
transferring instructions from said branch line to said main line advanced portion upon concluding said concurrent execution steps

31. The method of claim 30 further comprising:
preserving said initial order of said instructions upon performing said transferring step.

32. The method of claim 29 further comprising:
associating instruction sequence number information with each said instruction in said processor instruction pipeline.

33. The method of claim 32 wherein said associating step is performed upon dispatching each said instruction from said main line initial portion to said branch line.

34. The method of claim 29 wherein said instructions in said branch line do not depend on data from instructions outside said branch line.

35. The method of claim 29 further comprising:
not dispatching instructions from said main line to any branch line segment that is full.

36. A processor instruction pipeline comprising:
a main line having an initial portion and an advanced portion;
a branch line disposed between said initial portion and said advanced portion;
instructions disposed within said processor instruction pipeline in an initial order, wherein said processor instruction pipeline is operative to:
a) execute at least one wait cycle by at least one wait instruction in said main line advanced portion,
b) execute at least one wait cycle by at least one wait instruction in said main line initial portion, said execution steps of a) and b) occurring concurrently, and
c) buffer a selection of said instructions in said branch line during said concurrent execution steps.

37. The processor instruction pipeline of claim 36 wherein said pipeline is further operable to:
transfer instructions from said branch line to said main line advanced portion upon concluding said concurrent execution steps.

38. The processor instruction pipeline of claim 37 wherein said pipeline is further operable to:
preserve said initial order of said instructions upon performing said transferring step.
